(19) United States
(12) Patent Application Publication
(10) Pub. No.: US 2009/0229329 A1
(43) Pub. Date: Sep. 17, 2009

(54) Combination Lock Simulating a Slot Machine

(75) Inventor: Scott L. Star, New York, NY (US)

Correspondence Address: LAW OFFICE OF GERARD F. DUNNE, PC, 156 FIFTH AVENUE, SUITE 1223, NEW YORK, NY, 10010, US

(73) Assignee: EB Brands Holdings, Inc., Yonkers, NY (US)

(21) Appl. No.: 12/402,213

(22) Filed: Mar. 11, 2009

Related U.S. Application Data
(60) Provisional application No. 61/069,119, filed on Mar. 12, 2008.

(51) Int. Cl. E05B 37/10; E05B 15/12; E05B 1/00

(52) U.S. Cl. 70/284; 70/321; 70/332

(57) ABSTRACT

A combination lock adapted to simulate a slot-machine including a housing, a rotating wheel assembly, a u-shaped hasp, and a releasing mechanism, said releasing mechanism including an external lever-arm. The rotating wheel assembly is partially within said housing including a plurality of rotatable wheels, each rotatable wheel having a plurality of symbols adapted to simulate the wheels on a slot machine. The u-shaped hasp having a terminating end pivotably connected within the housing and a shackling end adapted to be held within the housing by the releasing mechanism. Said releasing mechanism including a lever-arm having one end extending beyond the housing simulating the actuating arm of a slot machine, and said lever-arm adapted to be actuated when the wheels of the rotatable wheel assembly have been aligned in a pre-determined position, whereby actuation of the lever-arm releases the shackling end of the u-shaped hasp, thereby opening the lock.

### FIELD OF THE INVENTION

The present invention relates to an improved combination lock primarily designed for use as a luggage lock.

### BACKGROUND OF THE INVENTION

Many styles of luggage locks are known, and it has become desirable to provide a lock simulating an area of interest of the potential user. Sports lock are, for example, known which simulate a game ball such as a soccer ball or basketball.

Combination luggage locks conventionally are arranged using a combination assembly of rotating wheels adapted to engage a shackling u-shaped hasp such that rotating the wheels into the proper position enables one end of the u-shaped hasp to be released, thereby opening the lock. Such locks often incorporate a secondary key-hole mechanism enabling an alternative means of opening the lock. Present security measures for air travel now require such key-hole mechanisms on luggage locks. The locks disclosed in U.S. Pat. Nos. 972,171; 3,837,189; 7.047,773; 7,204,108; and 7,370,497, for example, are constructed of rotating combination wheel assembly adapted to directly engage the u-shaped hasp with an alternative key-hole assembly for opening the lock.

However, such combination locks are not suited to simulate the function of a slot gaming machine, since they are lacking an external lever-arm adapted to engage the rotating wheel assemble of the lock. Therefor, it is an object of the present invention to provide an external lever-arm as an intermediate mechanism between the rotating wheels and the u-shaped hasp, whereby rotation of the wheels into the proper alignment is not alone sufficient to release the hasp; the user must also actuate the lever-arm, in a manner simulating the mechanical operation of a slot machine, to release the hasp.

### SUMMARY OF THE INVENTION

According to the present invention, a lock is provided resembling the traditional “one arm bandit” slot or gaming machine. The lock is a combination lock wherein the symbols on the several rotating wheels can be rotated to set the combination, simulating the rotating wheels that would be provided on a slot machine. The combination lock operates by setting the proper combination by rotating the wheels much in the manner of a conventional combination lock. But to release the hasp of the lock, a lever must additionally be actuated. This lever simulates the handle arm of a traditional “one arm bandit” style slot machine that is pulled by the user to spin the dials of the slot machine. Actuation of the lever releases the hasp to open the lock. The present invention also provides for the inclusion of an alternative traditional key-hole mechanism as a secondary means to release the hasp and open the lock.

### BRIEF DESCRIPTION OF THE DRAWINGS

The attached figures illustrate the mechanics of a lock according to the present invention.

FIG. 1 illustrates the interior of a lock of the present invention in a locked condition;

FIG. 2 illustrates the interior of the lock of the present invention in the unlocked condition;

FIG. 3 illustrates the interior of a lock of the present invention in a locked condition from the reverse side of FIG. 1.

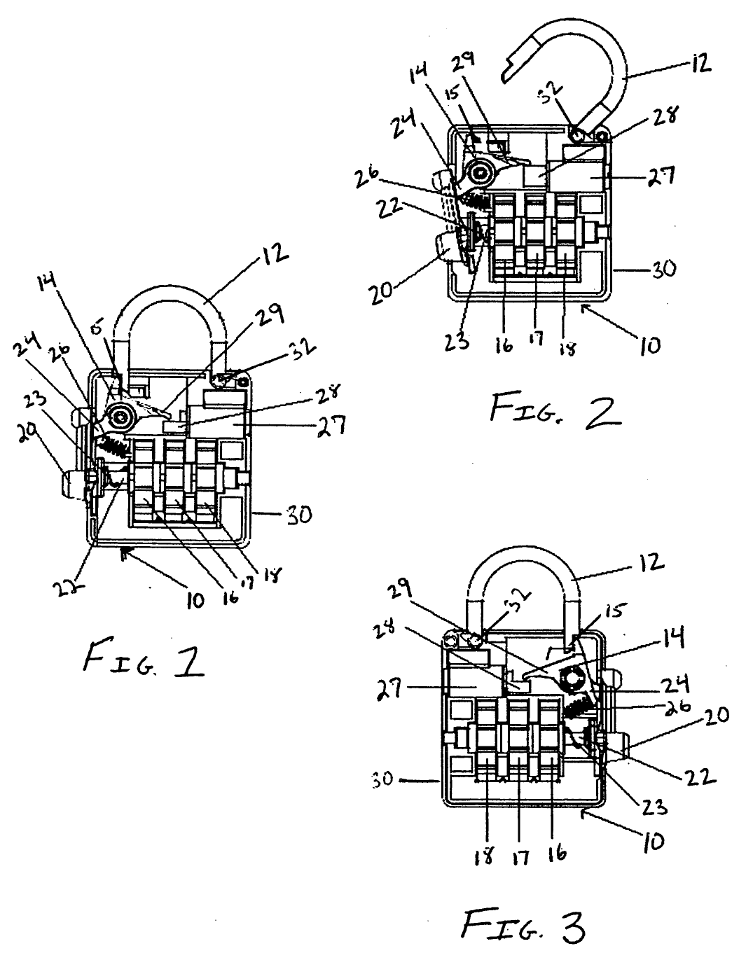

### DETAILED DESCRIPTION OF A PREFERRED EMBODIMENT

A lock 10 as shown has a housing 30, whereas each end of a u-shaped hasp 12 enters housing 30. One end of hasp 12 is pivotably affixed to fulcrum 32 within the housing, and the other end held in a locked position within housing 30 by notch 15. On one end of rotatable clasp 14. Clasp 14 can be rotated to allow notch 15 to release one end of the hasp 12. Clasp 14 is rotated by the user rotating wheels 16, 17 and 18 in a conventional manner for a combination lock and actuating lever-arm 20.

A lever-arm 20 is provided on the side of the lock and extends beyond housing 30. The lever-arm 20 resembles the lever-arm of a “one arm bandit” slot machine, and the rotating dials 16, 17 and 18 resemble the spinning wheels of a slot machine.

When the wheels 16, 17 and 18 are rotated to provide the proper combination to open the lock, the lever-arm 20 may be actuated to rotate clasp 14 and release the hasp for opening the lock.

More specifically, when the wheels 16, 17 and 18 have been rotated to position the proper combination, shaft 22 is aligned so that it may be slide inwardly when the lever-arm 20 is actuated against spring 23. The lever-arm 20 abuts stub end 24 of clasp 14 and when lever-arm 20 is actuated when the proper combination is set, clasp 14 rotates, compressing spring 26, and causing clasp 14 to rotate into the position shown in FIG. 2 and notch 15 releases hasp 12 and allows the lock to be opened.

Alternatively, clasp 14 can be rotated by use of the proper key in the key-hole mechanism 27. More specifically, when the proper key is inserted in key-hole mechanism 27 and rotated, rod 28 is rotated. Rod 28 abuts engaging end 29 of clasp 14 such that rotation of rod 28 causes clasp 14 to rotate into the position shown in FIG. 2 and notch 15 releases hasp 12 and allows the lock to be opened.

What is claimed is:

1. A combination lock adapted to simulate a slot-machine including a housing, a rotating wheel assembly partially within said housing having a plurality of rotatable wheels, each rotatable wheel having a plurality of symbols adapted to simulate the wheels on a slot machine, a u-shaped hasp having a terminating end pivotably connected within the housing and a shackling end adapted to be held within the housing by a releasing mechanism, said releasing mechanism including a lever-arm having one end extending beyond the housing simulating the actuating arm of a slot machine, said lever-arm adapted to be actuated when the wheels of the rotatable wheel assembly have been aligned in a pre-determined position, whereby actuation of the lever-arm releases the shackling end of the u-shaped hasp, thereby opening the lock.

2. A combination lock as set forth in claim 1, wherein the rotatable wheel assembly further comprises a cylindrical shaft, said cylindrical shaft being inserted perpendicularly through the all of the rotatable wheels of the rotatable wheel assembly, and one end of the cylindrical shaft being adapted to engage the lever-arm, whereby when the wheels of the rotating wheel assembly have been aligned in a pre-determined position, said shaft becomes slidable within the dials allowing actuation of the lever-arm, thereby opening the lock.

3. A combination lock as set forth in claim 2 further comprising a rotatable clasp within the housing, said rotatable clasp having a shackling end and an engaging end, said shackling end adapted to be secured in place by the shackling end of the u-shaped hasp, and said engaging end of the rotatable clasp adapted to engage the lever-arm, whereby, when the wheels of the rotating wheel assembly have been aligned in a pre-determined position, actuation of the lever-arm rotates the rotatable clasp, said rotation causing the shackling end of the rotatable clasp to release the shackling end of the u-shaped hasp, thereby opening the lock.

4. A combination lock as set forth in claim 3 further comprising a key turning assembly having a first and second end, said first end protruding through the housing and having a key hole, and said second end adapted to engage the shackling end of the u-shaped hasp, whereby, if the proper key is inserted in said key-hole and rotated, the second end of key turning assembly rotates, releasing the shackling end of the u-shaped hasp, thereby opening the lock.

5. A combination lock as set forth in claim 1 further comprising a key turning assembly having a first and second end, said first end protruding through the housing and having a key hole, and said second end adapted to engage the shackling end of the u-shaped hasp, whereby, if the proper key is inserted in said key-hole and rotated, the second end of key turning assembly rotates, releasing the shackling end of the u-shaped hasp, thereby opening the lock.

6. A combination lock adapted to simulate a slot-machine comprising a housing, a rotating wheel assembly, a u-shaped hasp having a terminating end and a shackling end, a rotatable clasp having a shackling end and an engaging end, and a lever-arm having a first and second end:
said housing having a plurality of parallel openings for holding a plurality of rotatable wheels, one side of said housing having a first receiving whole for securing the terminating end of the u-shaped hasp and a second receiving whole for securing the shackling end of the u-shaped hasp, and a second side having an opening adapted for holding a lever arm;
said rotating wheel assembly adapted to be held partially within said housing and comprising a plurality of rotatable wheels arranged in parallel and a cylindrical shaft, said rotatable wheels partially protruding through the parallel openings in the housing beyond the exterior of said housing, each rotatable wheel having a plurality of symbols adapted to simulate the wheels on a slot machine, and said cylindrical shaft inserted perpendicularly through said rotatable wheels, one end of said cylindrical shaft being adapted to engage the first end of the lever-arm, whereby when said dials are in the proper alignment with said cylindrical shaft, said cylindrical shaft is slidable within the dials when the lever-arm is actuated;
said lever-arm being partially within one side of the housing and partially extending beyond the exterior of the housing simulating the actuating arm of a slot machine, said lever-arm adapted to be pivotable, the first end of said lever-arm is adapted to engage the rotating wheel assembly's cylindrical shaft, and the second end is adapted to engage the rotatable clasp, whereby, when the wheels of the rotatable wheel assembly have been aligned in a pre-determined position, actuation of the first end of the lever-arm causes the rotating wheel assembly's cylindrical shaft to slide within the wheels allowing the lever-arm to pivot so the second end of the lever-arm engages the rotatable clasp, thereby rotating said clasp;
said rotatable clasp being imbedded within the housing having a shackling end and an engaging end, said shackling end having a notch adapted for securing the shackling end of the u-shaped hasp in place, and said engaging end adapted to engage the second end of the lever-arm, whereby when said lever-arm is actuated, the engaging end of the rotatable clasp is engaged, thereby rotating said clasp, said rotation causing the shackling end to release the u-shaped hasp; and
said u-shaped hasp being adapted so both ends are receivable into the housing through the first and second receiving wholes in the housing, the terminating end being permanently attached to a fulcrum within the housing allowing the u-shaped hasp to pivot about said fulcrum, the shackling end of the u-shaped hasp is adapted to engage the shackling end of the rotatable clasp, whereby rotation of the shackling end of said rotatable clasp will release the shackling end of the u-shaped hasp, thereby opening the lock.
